(19) United States
(12) Patent Application Publication
(10) Pub. No.: US 2010/0310091 A1
(43) Pub. Date: Dec. 9, 2010

(54) SELECTOR FOR VEHICLE AUDIO SYSTEM

(76) Inventor: Dave Choi, Marysville, OH (US)

Correspondence Address: Emerson, Thomson & Bennett, LLC, 1914 Akron-Peninsula Road, Akron, OH, 44313, US

(21) Appl. No.: 12/478,350

(22) Filed: Jun. 4, 2009

(51) Int. Cl. H04B 1/00

(52) U.S. Cl. 381/86

(57) ABSTRACT

An audio transmission device that is mountable to a vehicle may include: an audio input device that receives audio input signals from one or more audio sources; an audio output device that provides audio output signals in response to the audio input signals; a knob that is rotatably adjustable with respect to the audio transmission device to adjust the audio transmission device to select between audio functions; an audio function indicator having an indication site for each audio function; and, a touch sensor that senses if the knob is being touched. The audio transmission device is adjustable between audio functions without creating the annoying “channel flipping” effect currently experienced in the art.

### BACKGROUND OF THE INVENTION

A. Field of Invention

This invention pertains to methods and apparatuses regarding vehicle audio systems and, more specifically, to methods and apparatuses regarding a vehicle audio system having a selector to change audio function settings of the audio system.

B. Description of the Related Art

It is known to provide vehicles with audio systems that typically include an audio transmission device (sometimes referred to as a “head unit”) that is connected to one more audio sources, such as CD players, cassette players, AM tuners, FM tuners, XM tuners, MP3 players, and the like. The audio transmission device generally includes an audio input device that receives audio input signals from the audio sources, an amplifier that amplifies the input signals, and an audio output device that provides audio output signals to one or more speakers in response to the audio input signals. The audio transmission device also has one or more selectors by which the operator can select between various audio functions. The operator may use a selector, for example, to adjust the audio transmission device between one audio source, the CD player for instance, and another audio source, the FM tuner, for instance. The operator may use other selectors to adjust a particular audio source. The operator may use a selector to adjust the CD player between one CD, CD 1 for instance, and another CD, CD 5, for instance. As another example, the operator may use a selector to adjust the currently playing CD between one track, track 7 for instance, and another track, track 12, for instance. As yet another audio function example, the operator may use a selector to adjust the volume of the audio transmission device.

While known audio transmission devices generally work well for their intended purposes, they have limitations. As audio transmission devices grow in complexity, the human-machine interface (HMI) grows in complexity. When button based selectors are used, the transmission device becomes cluttered with an intimidating array of buttons. As the number of buttons increases, the amount of space taken up by the buttons increases and they must be placed closer together. When menu based selectors are used, the menus become longer and require long, drawn out menu “drill down” to make the desired audio function selection.

One known solution to reduce the growing HMI problem is the use of a rotary knob as the selector. The drawback of using a rotary knob, however, is that the operator must rotate through each audio function setting before arriving at the desired audio function setting. As one example, where the knob controls the audio source, if the rotary knob is arrayed in the following order, AM, FM, CD, XM, and the operator wants to switch from AM to XM, the operator must rotate the knob through and hear the outputs from FM and CD before arriving at the desired XM. As another example, where the knob controls preset channels, if the channel is set to channel 1 and the user wants to change to channel 4, the user must rotate through and hear output from channels 2 and 3 before reaching channel 4. This creates an unwanted and annoying “channel flipping” effect.

What is needed is an audio transmission device that provides the advantages of a knob selector but without the undesirable channel flipping effects in known audio devices.

### SUMMARY OF THE INVENTION

According to one embodiment of the invention, a method may comprise the steps of: (A) providing at least a first audio source; (B) providing at least first, second, and third audio functions; (C) providing an audio transmission device that is mountable to an associated vehicle, the audio transmission device comprising: (1) an audio input device that receives audio input signals from the audio source; (2) an audio output device that provides audio output signals in response to the audio input signals; (3) a knob that is movably adjustable with respect to the audio transmission device to adjust the audio transmission device to select between the audio functions; and, (4) a touch sensor that senses if the knob is being touched by an associated person and if the knob is not being touched by the associated person; (D) providing the knob in a first position corresponding to the first audio function with the knob untouched to cause the audio transmission device to provide audio output signals in response to the first audio function; (E) touching the knob while in the first position; (F) moving the knob to a second position corresponding to the second audio function; (G) moving the knob to a third position corresponding to the third audio function; (H) releasing the knob in the third position to cause the audio transmission device to provide audio output signals in response to the third audio function. Wherein steps (D) though (H) are done in sequential order, during steps (E) though (G) the knob is continuously touched by the associated person; and, during steps (E) though (G) the audio transmission device continuously provides audio output signals in response to the first audio function.

According to another embodiment of the invention, an audio system may comprise: at least a first audio source; at least first and second audio functions; an audio transmission device that is mountable to an associated vehicle, the audio transmission device comprising: an audio input device that receives audio input signals from the audio source; an audio output device that provides audio output signals in response to the audio input signals; a knob that is movably adjustable with respect to the audio transmission device to adjust the audio transmission device to select between the audio functions; an audio function indicator having an indication site for each audio function; each indication site having at least first, second, and third indication options; and, a touch sensor that senses if the knob is being touched by an associated person and if the knob is not being touched by the associated person. The audio transmission device may be adjustable: (1) from a first condition where: the touch sensor senses that the knob is not being touched; the knob is in a first position corresponding to the first audio function; the indication site for the first audio function has the first indication option; the indication site for the second audio function has the third indication option; and, the audio transmission device provides audio output signals in response to the first audio function; (2) to a second condition where: the touch sensor senses that the knob is being touched; the knob is in the first position corresponding to the first audio function; the indication site for the first audio function has the second indication option; and, the indication site for the second audio function has the third indication option; (3) then to a third condition where: the touch sensor senses that the knob is being touched; the knob is in the second position corresponding to the second audio function; the indication site for the first audio function has the first indication option; and, the indication site for the second audio function has the second indication option; and, (4) then to a fourth condition where: the touch sensor senses that the knob is not being touched; the knob is in the second position corresponding to the second audio function; the indication site for the first audio function has the third indication option; the indication site for the second audio function has the first indication option; and, the audio transmission device provides audio output signals in response to the second audio function. During and between the second and third conditions: (1) the touch sensor continuously senses that the knob is being touched; and, (2) the audio transmission device continuously provides audio output signals in response to the first audio function.

### BRIEF DESCRIPTION OF THE DRAWINGS

The exemplary embodiments may take physical form in certain parts and arrangement of parts, embodiments of which will be described in detail in this specification and illustrated in the accompanying drawings which form a part hereof and wherein:

FIG. 1 is a perspective view of a vehicle interior.

FIG. 2 is a schematic representation of an audio system that may include an audio transmission device according to one exemplary embodiment of this invention.

FIG. 3 is a schematic representation of an audio system that may include an audio transmission device according to another exemplary embodiment of this invention.

FIG. 4 is a schematic representation of an audio system that may include an audio transmission device according to yet another exemplary embodiment of this invention.

FIGS. 5(a) through 5(e) illustrate the operation of the knob, audio function indicator and knob touch indicator according to the embodiment shown in FIG. 2.

FIG. 6 is a flowchart showing the general operation of the invention according to one exemplary embodiment of this invention.

FIG. 7 is a flowchart showing the general operation of the invention according to another exemplary embodiment of this invention.

FIG. 8 is an electric circuit schematic according to one embodiment of this invention.

### DETAILED DESCRIPTION OF THE INVENTION

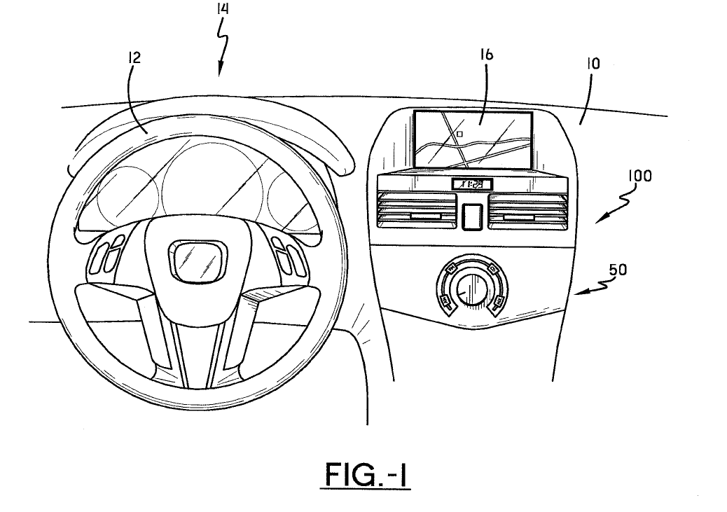

Referring now to the drawings wherein the showings are for purposes of illustrating exemplary embodiments only and not for purposes of limiting the same, and wherein like reference numerals are understood to refer to like components, FIG. 1 shows the interior of a vehicle that may include a steering wheel 12 equipped with vehicle controls 14. The vehicle may also include an instrument panel or dash board 10. Mounted to the instrument panel 10 may be a navigation system 16 and the controls of an audio system 50 that provides audio output to vehicle passengers. It should be noted that while an automotive passenger vehicle is shown, this invention will work well with other vehicles including all types of trucks, motorcycles, all-terrain vehicles (ATVs), sport utility vehicles (SUVs), vans, boats, airplanes, etc., and for other purposes as well.

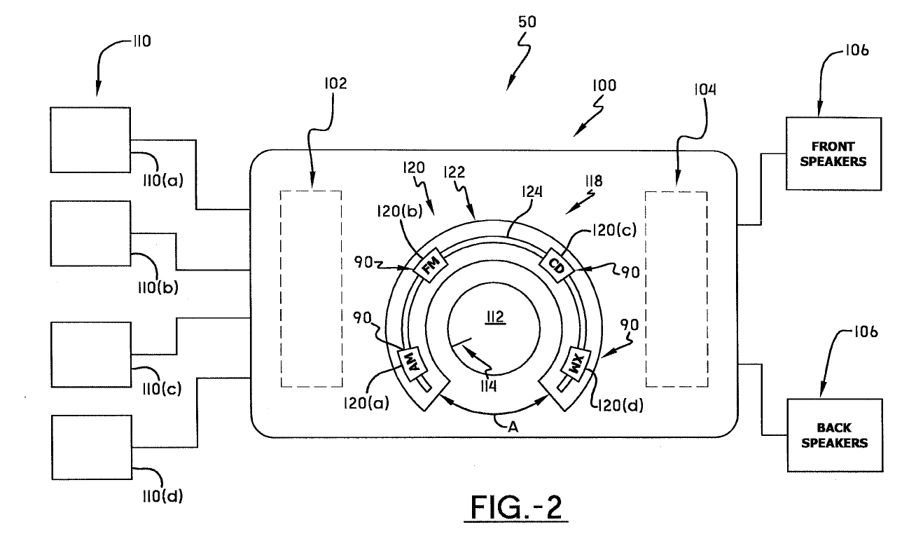

With reference now to FIGS. 1-2, the audio system 50 may include an audio transmission device or head unit 100 that may include an audio input device 102 (shown schematically in FIG. 2) that receives audio input signals from any number of audio sources 110, an amplifier (not shown) that amplifies the input signals, and an audio output device 104 (shown schematically in FIG. 2) that provides audio output signals in response to the audio input signals to one or more speakers 106 or one or more headphone jacks (not shown). The general operation of an audio system 50 in processing input and output signals is well known and thus will not be described further here. However, it should be noted that the audio system 50 may include any conventional components that are not shown, for clarity. While the audio transmission device 100 is shown mounted to the instrument panel 10 within a passenger compartment, it should be noted that the audio transmission device 100 of this invention may be mounted to the vehicle in any manner chosen with the sound judgment of a person of skill in the art.

With reference now to FIGS. 1-2, the audio system 50 may be adjusted between various audio functions 90. By “audio function” it is meant any function that affects the audio characteristics of the audio transmission device 100. Audio functions 90 may include the audio sources 110. For clarity, each audio source is referenced 110 with an additional identifying lettered suffix. Specifically, 110(a) references a first audio source, 110(b) references a second audio source, 110(c) references a third audio source, and 110(d) references a fourth audio source. The audio sources may be of any number and type known in the art. Some non-limiting examples include: an AM radio tuner audio source, an FM radio tuner audio source, a Compact Disk (CD) audio source, an XM radio receiver audio source, an auxiliary audio source (such as an MP3 player or flash drive), and a Digital Video Disc (DVD) audio source.

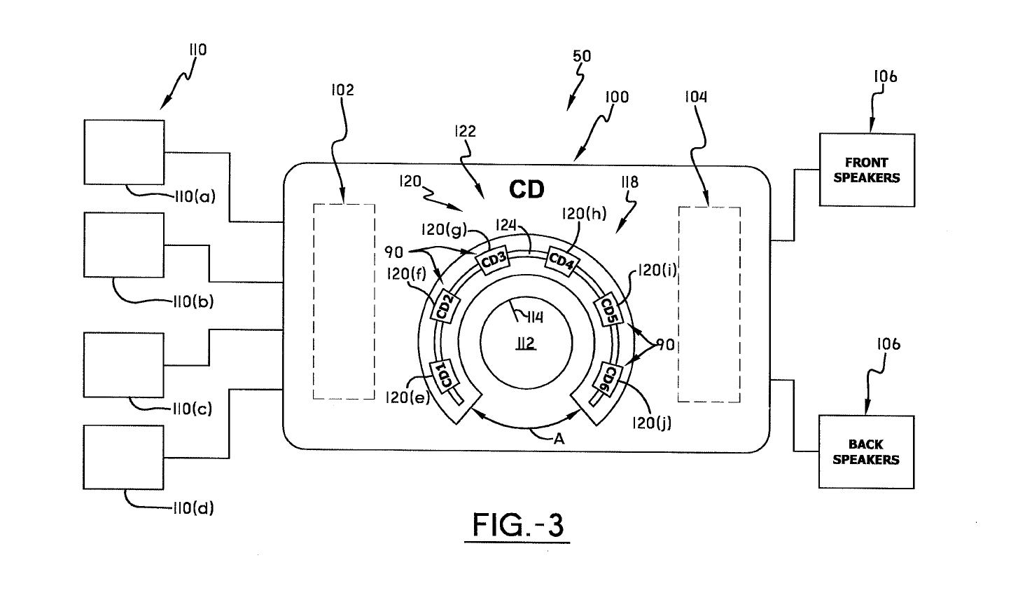

With reference now to FIGS. 2-3, audio functions 90 also include the sub-audio choices found within any particular audio source 110. By “sub-audio choice” it is meant any function that affects the audio characteristics of a particular audio source 110 (and thus also affects the audio characteristics of the audio transmission device 100). A CD audio source, for example, as shown in FIG. 3, may be capable of being adjusted to play one of six different CDs. In this case, each of the six CD options is an audio function 90 that is a sub-audio choice for the CD audio source. The CD audio source may also be capable of being adjusted to play any one of numerous tracks (not shown) on any specific CD. In this case, each of the track options is an audio function 90 that is a sub-audio choice for the CD audio source. An AM radio tuner audio source may be capable of being adjusted to play any one of numerous AM frequencies (commonly referred to as “stations”). In this case, each of the AM frequency options is an audio function 90 that is a sub-audio choice for the AM radio tuner audio source. Similarly, an FM radio tuner audio source may be capable of being adjusted to play any one of numerous FM frequencies, or stations, and each of the FM frequency options is an audio function 90 that is a sub-audio choice for the FM radio tuner audio source. Likewise, an XM radio tuner audio source may be capable of being adjusted to play any one of numerous XM frequencies (commonly referred to as “channels”), and each of the XM frequency options is an audio function 90 that is a sub-audio choice for the XM radio tuner audio source. In the same way, each of the track options for an MP3 player is an audio function 90 that is a sub-audio choice for the MP3 player audio source and each of the track options for a DVD is an audio function 90 that is a sub-audio choice for a DVD audio source. It should be noted, however, that these particular sub-audio choices are exemplary only as any sub-audio choice chosen with the sound judgment of a person of skill in the art will work well with this invention.

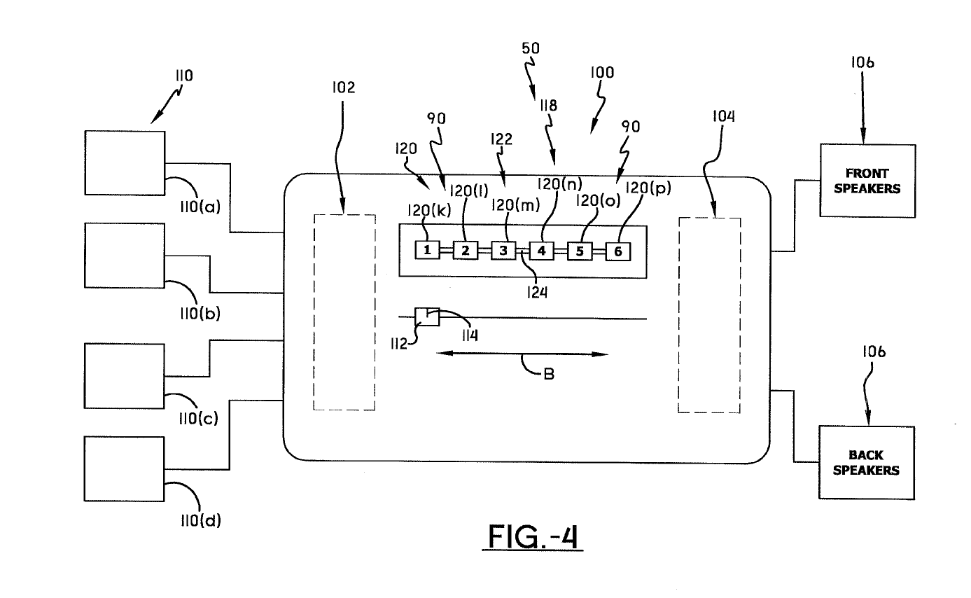

With reference now to FIGS. 2-4, it should be understood that audio functions 90 are not limited to audio source 110 options and sub-audio choice options. Another example of an audio function 90 is commonly referred to as a “preset” or “preselect” option, shown in FIG. 4. One preset option, for example, may be a specific AM station while another is a specific XM channel while a third preset option may be a specific CD. Each of the preset options is an audio function 90. Other non-limiting audio functions 90 may include volume control, tone control (such as various audio equalizer options), and balance options (such as adjusting between right and left side speakers and/or between front and rear speakers).

With continuing reference to FIGS. 2-4, the audio transmission device 100 may include a knob 112, that is movably adjustable with respect to the audio transmission device 100 to adjust the audio transmission device 100 to select between the desired audio functions 90. While FIGS. 2-4 each show a single knob 112 used to adjust between a particular set of audio functions, it should be understood that any number of knobs chosen with the sound judgment of a person of skill in the art may be used to adjust between various audio functions 90 and/or sets of audio functions. A mark 114 may be provided on the knob 112 to provide a visual sign to the operator as to which audio function 90 is designated. In one embodiment, shown in FIGS. 2 and 3, the knob 112 may be rotatably adjustable with respect to the audio transmission device 100 to adjust the audio transmission device 100 to select between the audio functions 90. The knob 112 may be, for example, rotatable about its central axis in direction A. In another embodiment, shown in FIG. 4, the knob 112 may be slidably adjustable with respect to the audio transmission device 100 to select between the audio functions 90. The knob 112 may be, for example, horizontally slidable in direction B. It should be understood that rotation in direction A and sliding motion in direction B are exemplary only because any movable adjustment of the knob 112 chosen with the sound judgment of a person of skill in the art will work well with this invention.

Still referring to FIGS. 2-4, the audio transmission device 100 may also include an audio function indicator 118. The audio function indicator 118 may have an indication site 120 for each audio function 90. For clarity, each audio source indication site is referenced 120 with an additional identifying lettered suffix. Specifically for the audio function indication sites shown in FIG. 2: 120(a) references an AM radio tuner indication site, 120(b) references an FM radio tuner indication site, 120(c) references a compact disk (CD) indication site, and 120(d) references an XM radio receiver indication site. Specifically for the audio function indication sites shown in FIG. 3: 120(e) references CD disc 1 indication site, 120(f) references CD disc 2 indication site, 120(g) references CD disc 3 indication site, 120(h) references CD disc 4 indication site, 120(i) references CD disc 5 indication site, and 120(j) references CD disc 6 indication site. Specifically for the audio function indication sites shown in FIG. 4: 120(k) references preset option 1 indication site, 120(l) references preset option 2 indication site, 120(m) references preset option 3 indication site, 120(n) references preset option 4 indication site, 120(o) references preset option 5 indication site, and 120(p) references preset option 6 indication site. It should be understood that the specific indication sites 120 shown are exemplary only as any indication site corresponding to an audio function 90 will work with this invention. While each audio source indication site 120 is shown to have a rectangular or quasi-rectangular shape, it is to be understood that the indication sites 120 can have any shape chosen with the sound judgment of a person of skill in the art. While the audio function indicator 118 is shown to be arced about the perimeter of the knob 112 in FIGS. 2-3 and to be linearly arrayed above the knob 112 in FIG. 4, it should be noted these locations are exemplary only as any location for the audio function indicator 118 chosen with the sound judgment of a person of skill in the art will work well with this invention.

With reference now to FIG. 2-5, each indication site 120 may provide at least three indication options. In one embodiment, the indication options are visual options. In one specific embodiment, the three indication options include light sources that provide distinct colors; red, yellow, and green, for one example. In another specific embodiment, at least one of the three indication options is the provision of no illumination or relative darkness; that is, the light source is blocked or “off.” One non-limiting example of indication options using this embodiment is white, blue and relative darkness. Any light source chosen with the sound judgment of a person of skill in the art will work well with this invention. Some non-limiting examples include: light emitting diodes (LED); light bulbs; and, other electroluminescent devices. Another visual embodiment is the use of a graphics display to provide the indication. Non-limiting examples of graphic displays that could be used with this invention include liquid crystal displays, thin film transistor displays, cathode ray tube displays, and projection displays. In yet another embodiment, the indication options are audio options. In one specific embodiment, the three indication options include audio sources that provide distinct sounds. In yet another embodiment, the indication options combine visual and audio options.

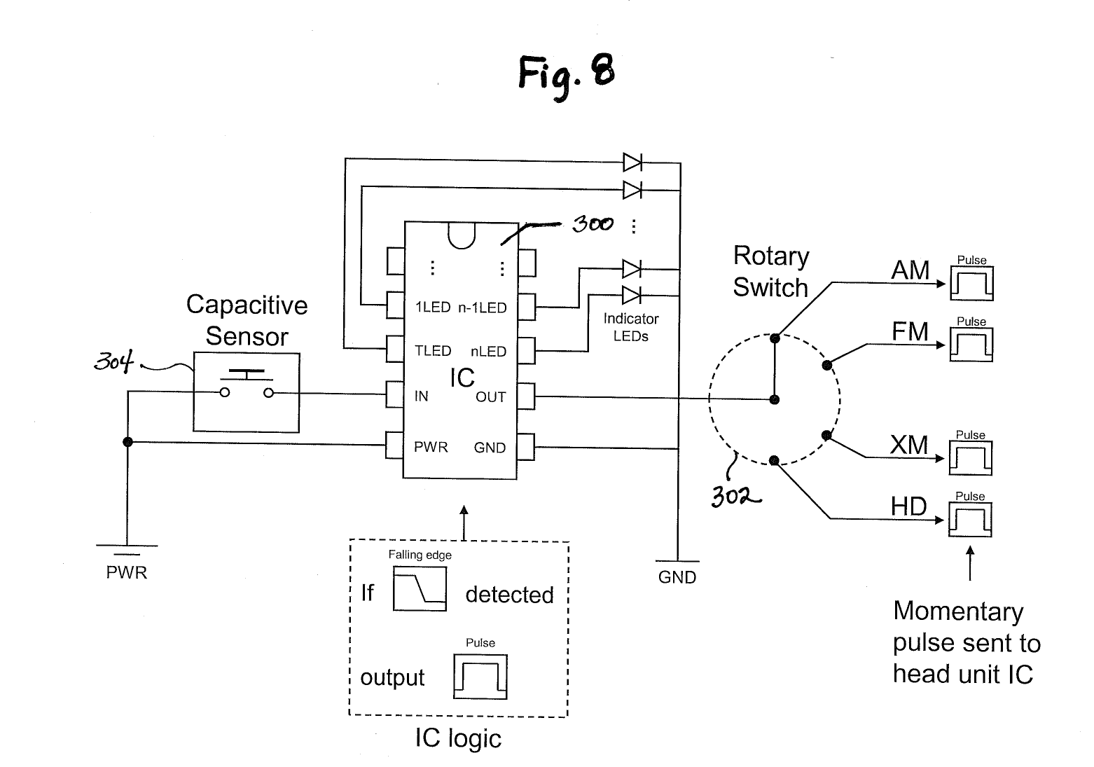

With reference now to FIGS. 1, 2 and 8, one example of an electric circuit that could be used with the audio transmission device 100 is shown in schematic form in FIG. 8. An integrated circuit (IC) 300 may be operatively connected to a power source (PWR) and ground (GND) as shown. The IC 300 may also be operatively connected to an electric position switch 302 that switches based on the position of the knob 112 and an electric touch sensor switch 304 that switches based on whether or not the knob 112 is being touched by an operator. In one embodiment, the position switch 302 may be a solid state logic gate device using an encoder or a rotary switch. While the position switch 302 shown is a rotary switch that determines the angular position of a rotatable knob 112, it should be understood that linear position switches known to those of skill in the art can also be used with this invention to determine the linear position of a slidable knob 112. For the embodiment shown, the touch sensor switch 304 comprises a capacitive sensor switch but it is to be understood that this is simply one example of a touch sensor switch that will work with this invention. FIG. 8 also illustrates one embodiment of IC logic that generates the output shown based on the input detected. The momentary pulses sent to the audio transmission device 100 based on the position of the knob 112 as determined by the position switch 302 is also illustrated. As the operation of the electric circuit shown, including the light emitting diodes (LEDs), is well known to those of skill in the art, further details will not be provided here.

With reference now to FIGS. 2-7, in one embodiment, the audio transmission device 100 also includes a knob touch indicator 122 having an indication site 124 that provides at least two indication options; one to indicate that the knob is being touched by the operator and another to indicate that the knob is not being touched. In one embodiment, the indication options are visual options. In one specific embodiment, the two indication options include light sources that provide distinct colors; yellow and green, for example. In another specific embodiment, one of the indication options is the provision of no illumination or relative darkness. Any light source chosen with the sound judgment of a person of skill in the art will work well with this invention. Some non-limiting examples include: light emitting diodes (LEDs); light bulbs; and other electroluminescent devices. Another visual embodiment is the use of a graphics display to provide the indication. Non-limiting examples of graphic displays that could be used with this invention include liquid crystal displays, thin film transistor displays, cathode ray tube displays, and projection displays. While the knob touch indication site 124 is shown to have a arced shape in FIGS. 2-3 and a linear shape in FIG. 4, and is positioned between the indication sites 120, it is to be understood that the indication sites 120 can have any shape and be positioned anywhere chosen with the sound judgment of a person of skill in the art. In yet another embodiment, the indication options are audio options. In one specific embodiment, the three indication options include audio sources that provide distinct sounds. In yet another embodiment, the indication options combine visual and audio options.

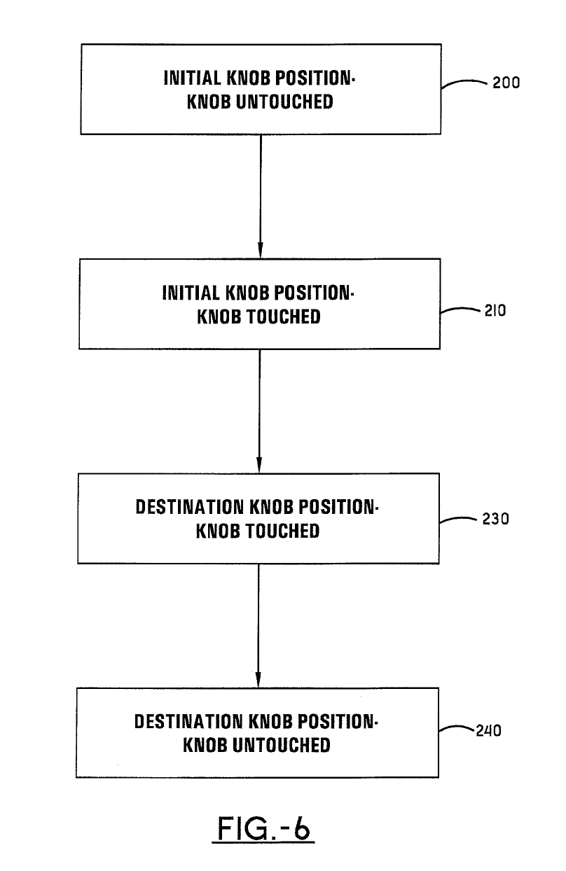

With reference now to FIGS. 2-4 and 6, the general operation of the audio transmission device 100 as it is adjusted between an initial audio function and a destination audio function according to one embodiment will now be discussed. The adjustment begins, as shown in FIG. 6, with a first condition 200 where the knob 112 is in the initial position and is untouched by the operator so that the initial audio function provides the audio output. At the next or second condition 210 the knob 112 remains in the initial position but is now touched by the operator. In this second condition the initial audio function continues to provide the audio output. At the next or third condition 230 the knob 112 has been moved into the destination position and continues to be touched by the operator. In this third condition the initial audio function continues to provide the audio output. Once the operator touches the knob 112 in condition 210, the operator continuously touches the knob 112 through the third condition 230. Throughout the first 200, second 210, and third 230 conditions the initial audio function continues to provide the audio output. This will described in more detail below. At the final or fourth condition 240 the knob 112 remains in the destination position but is now released (and thus no longer touched) by the operator. In this fourth condition the destination audio function provides the audio output.

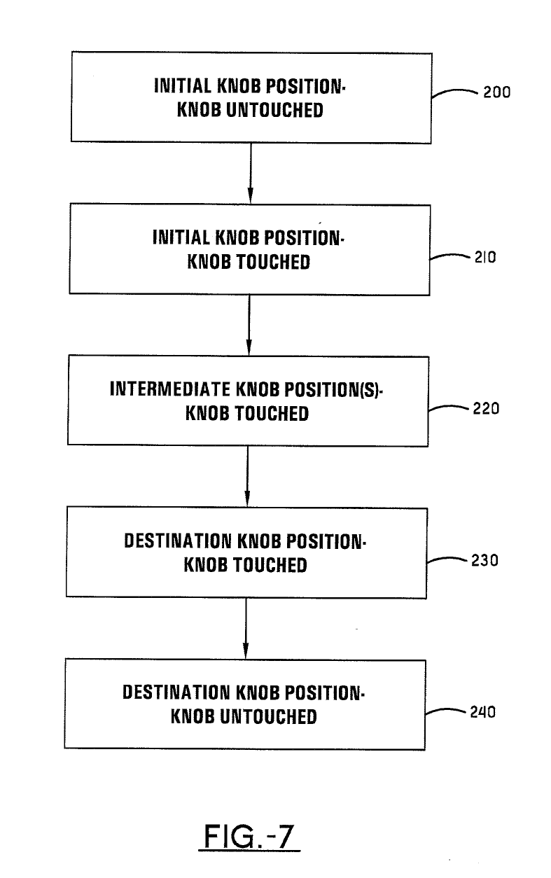

With reference now to FIGS. 2-4 and 7, the operation of the audio transmission device 100 as it is adjusted between an initial audio function and a destination audio function according to another embodiment will now be discussed. For this embodiment shown in FIG. 7, the first, second, third and fourth conditions 200, 210, 230 and 240 are the same as in the previous embodiment. The distinction here is the addition of one or more intermediate conditions 220 between the second and third conditions 210, 230. For each intermediate condition 220, the knob 112 has been moved into an intermediate position and continues to be touched by the operator. In other words, once the operator touches the knob 112 in condition 210, the operator continuously touches the knob 112 through all intermediate conditions and through the third condition 230. Throughout the first 200, second 210, intermediate 220, and third 230 conditions the initial audio function continues to provide the audio output. This will described in more detail below. However, it should be understood that no intermediate conditions 220 are required for this invention.

With reference now to FIGS. 2-4 and 5-7, three specific examples of operating the audio transmission device 100 to adjust between an initial audio function and a destination audio function will be described. However, it should be understood that these examples are illustrative only as any adjustment of the audio transmission device 100 between an initial audio function and a destination audio function chosen with the sound judgment of a person of skill in the art will work with this invention.

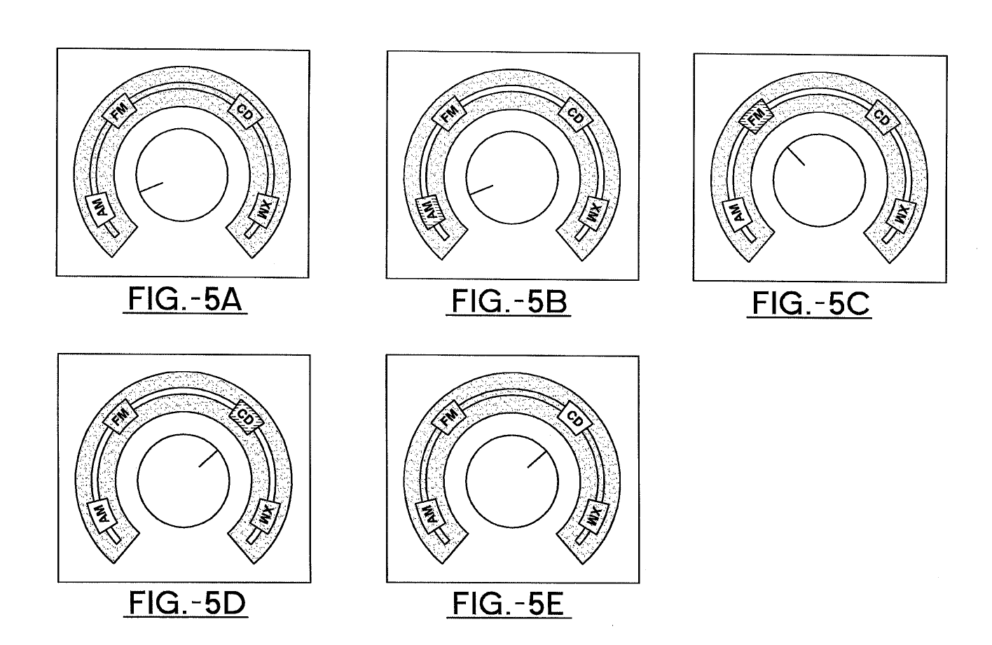

With reference now to FIGS. 2, 5, 7 and 8, the first example concerns the audio transmission device 100 shown in FIG. 2 where the particular audio source options are: an AM radio tuner audio source, an FM radio tuner audio source, a Compact Disk (CD) audio source, and an XM radio receiver audio source. For a specific example, the initial audio function 90 is the AM audio source and the destination audio function is the CD audio source. For this example the general operation is shown in FIG. 7. The audio transmission device 100 begins in the first condition 200 with the knob 112 in the initial AM position (as determined by the position switch 302) and untouched by the operator (as determined by the touch sensor touch sensor switch 304). As a result, the initial audio function, the AM audio source, provides the audio output. This condition is shown in FIG. 5(a). If the audio function indicator 118 is used, the mark 114 may “point” toward or designate the AM indication site 120(a). Because the audio transmission device 100 is providing audio output signals in response to the AM audio source and the knob 112 is untouched, the AM indication site 120(a) may provide a corresponding indication; such as providing a white color. While in this AM position with the knob 112 untouched, the other indication sites 120(b), 120(c), and 120(d) may provide a corresponding indication that they are neither designated nor providing the current audio function; such as relative darkness. If the knob touch indicator 122 is used, the indication site 124 may provide an indication that the knob is not being touched; such as relative darkness.

With continuing reference to FIGS. 2, 5, 7 and 8, to achieve the second condition 210, the operator touches the knob 112. This condition is shown in FIG. 5(b). Because the knob 112 remains in the AM position (as determined by the position switch 302) while the knob 112 is being touched (as determined by the touch sensor touch sensor switch 304), the AM audio source continues to provide the audio output. If the audio function indicator 118 is used, the mark 114 will continue to point toward or designate the AM indication site 120(a). The AM indication site 120(a) may provide an indication corresponding to the fact that the AM position is designated while the knob 112 is touched; such as providing a blue color. While in this AM position with the knob 112 touched, the other indication sites 120(b), 120(c), and 120(d) may continue to provide a corresponding indication that they are neither designated nor providing the current audio function; such as relative darkness. If the knob touch indicator 122 is used, the indication site 124 may provide an indication that the knob is now being touched; such as providing a white color.

With continuing reference to FIGS. 2, 5, 7 and 8, to achieve the next condition the operator begins rotating the knob 112 toward the CD position. As this rotation begins, the knob 112 is rotated to the FM position. This condition is shown in FIG. 5(c) and is considered an intermediate condition 220 in FIG. 7. Because the knob 112 is in the FM position (as determined by the position switch 302) and the knob 112 continues to be touched (as determined by the touch sensor touch sensor switch 304), the AM audio source continues to provide the audio output. If the audio function indicator 118 is used, the mark 114 will now point toward or designate the FM indication site 120(b). The FM indication site 120(b) may provide an indication corresponding to the fact that the FM position is designated while the knob 112 is touched; such as providing a blue color. Because the AM audio source continues to provide the audio output, the AM indication site 120(a) may provide a corresponding indication; such as providing a white color. Note that because the audio transmission device 100 continues to provide audio output signals in response to the AM audio source, the annoying “channel flipping” effect known in the prior art is avoided. While in this condition the other indication sites 120(c) and 120(d) may continue to provide a corresponding indication that they are neither designated nor providing the current audio function; such as relative darkness. If the knob touch indicator 122 is used, the indication site 124 may continue to provide an indication that the knob is being touched; such as providing a white color.

Still referring to FIGS. 2, 5, 7 and 8, to achieve the third condition 230, the operator continues rotating the knob 112, into the CD position. This condition is shown in FIG. 5(d). Because the knob 112 is in the CD position (as determined by the position switch 302) and the knob 112 continues to be touched (as determined by the touch sensor touch sensor switch 304), the AM audio source continues to provide the audio output. If the audio function indicator 118 is used, the mark 114 will now point toward or designate the CD indication site 120(c). The CD indication site 120(c) may provide an indication corresponding to the fact that the CD position is designated while the knob 112 is touched; such as providing a blue color. Because the AM audio source continues to provide the audio output, the AM indication site 120(a) may provide a corresponding indication; such as providing a white color. While in this condition the other indication sites 120(b) and 120(d) may provide a corresponding indication that they are neither designated nor providing the current audio function; such as relative darkness. If the knob touch indicator 122 is used, the indication site 124 may continue to provide an indication that the knob is being touched; such as providing a white color.

Finally, with continuing reference to FIGS. 2, 5, 7 and 8, to achieve the fourth and final condition 240, the destination audio function where the CD audio source provides the audio output, the operator releases the knob 112 in the CD position. This condition is shown in FIG. 5(e). Because the knob 112 is in the CD position (as determined by the position switch 302) and the knob 112 is no longer touched (as determined by the touch sensor touch sensor switch 304), the CD audio source now provides the audio output. Because the audio transmission device 100 is providing audio output signals in response to the CD audio source and the knob 112 is untouched, the CD indication site 120(c) may provide a corresponding indication; such as providing a white color. While in this CD position with the knob 112 untouched, the other indication sites 120(a), 120(b), and 120(d) may provide a corresponding indication that they are neither designated nor providing the current audio function; such as relative darkness. If the knob touch indicator 122 is used, the indication site 124 may provide an indication that the knob is not being touched; such as relative darkness. Note again that the audio transmission device 100 switches between audio input signals without the annoying “channel flipping” effect known in the prior art.

With reference now to FIGS. 3, 6 and 8, the second example concerns the audio transmission device 100 shown in FIG. 3 where the initial audio function 90 is the CD 3 audio function 90 and the destination audio function is the CD 4 audio function 90. For this example the general operation is shown in FIG. 6. The audio transmission device 100 begins in the first condition 200 with the knob 112 in the initial CD 3 position (as determined by the position switch 302) and untouched by the operator (as determined by the touch sensor touch sensor switch 304). As a result, the initial audio function, CD 3, provides the audio output. If the audio function indicator 118 is used, the mark 114 may “point” toward or designate the CD 3 indication site 120(g). Because the audio transmission device 100 is providing audio output signals in response to CD 3 and the knob 112 is untouched, the CD 3 indication site 120(g) may provide a corresponding indication; such as providing a white color. While in this CD 3 position with the knob 112 untouched, the other indication sites 120(e), 120(f), 120(h), 120(i) and 120(j) may provide a corresponding indication that they are neither designated nor providing the current audio function; such as relative darkness. If the knob touch indicator 122 is used, the indication site 124 may provide an indication that the knob is not being touched; such as relative darkness.

With continuing reference to FIGS. 3, 6 and 8, to achieve the second condition 210, the operator touches the knob 112. Because the knob 112 remains in the CD 3 position (as determined by the position switch 302) while the knob 112 is being touched (as determined by the touch sensor touch sensor switch 304), CD 3 continues to provide the audio output. If the audio function indicator 118 is used, the mark 114 will continue to point toward or designate the CD 3 indication site 120(g). The CD 3 indication site 120(g) may provide an indication corresponding to the fact that the CD 3 position is designated while the knob 112 is touched; such as providing a blue color. While in this CD 3 position with the knob 112 touched, the other indication sites 120(e), 120(f), 120(h), 120(i) and 120(j) may continue to provide a corresponding indication that they are neither designated nor providing the current audio function; such as relative darkness. If the knob touch indicator 122 is used, the indication site 124 may provide an indication that the knob is now being touched; such as providing a white color.

With continuing reference to FIGS. 3, 6 and 8, to achieve the third condition 230, the operator continues rotating the knob 112, into the CD 4 position. Note that in this example no intermediate conditions 220 (as shown in FIG. 7) are required. Because the knob 112 is in the CD 4 position (as determined by the position switch 302) and the knob 112 continues to be touched (as determined by the touch sensor touch sensor switch 304), CD 3 continues to provide the audio output. If the audio function indicator 118 is used, the mark 114 will now point toward or designate the CD 4 indication site 120(h). The CD 4 indication site 120(h) may provide an indication corresponding to the fact that the CD 4 position is designated while the knob 112 is touched; such as providing a blue color. Because CD 3 continues to provide the audio output, the CD 3 indication site 120(g) may provide a corresponding indication; such as providing a white color. While in this condition the other indication sites 120(e), 120(f), 120(i) and 120(j) may provide a corresponding indication that they are neither designated nor providing the current audio function; such as relative darkness. If the knob touch indicator 122 is used, the indication site 124 may continue to provide an indication that the knob is being touched; such as providing a white color.

Finally, with continuing reference to FIGS. 3, 6 and 8, to achieve the fourth and final condition 240, the destination audio function where CD 4 provides the audio output, the operator releases the knob 112 in the CD 4 position. Because the knob 112 is in the CD 4 position (as determined by the position switch 302) and the knob 112 is no longer touched (as determined by the touch sensor touch sensor switch 304), CD 4 now provides the audio output. Because the audio transmission device 100 is providing audio output signals in response to CD 4 and the knob 112 is untouched, the CD 4 indication site 120(h) may provide a corresponding indication; such as providing a white color. While in this CD 4 position with the knob 112 untouched, the other indication sites 120(e), 120(f), 120(g), 120(i) and 120(j) may provide a corresponding indication that they are neither designated nor providing the current audio function; such as relative darkness. If the knob touch indicator 122 is used, the indication site 124 may provide an indication that the knob is not being touched; such as relative darkness. Note again that the audio transmission device 100 switches between audio input signals without the annoying “channel flipping” effect known in the prior art.

With reference now to FIGS. 4, 7 and 8, the third example concerns the audio transmission device 100 shown in FIG. 4 where the initial audio function 90 is the preset option 6 and the destination audio function is the preset option 1. For this example the general operation is shown in FIG. 7. The audio transmission device 100 begins in the first condition 200 with the knob 112 in the initial preset option 6 (as determined by the position switch 302) and untouched by the operator (as determined by the touch sensor touch sensor switch 304). As a result, the initial audio function, preset option 6, provides the audio output. If the audio function indicator 118 is used, the mark 114 may “point” toward or designate preset option 6 indication site 120(p). Because the audio transmission device 100 is providing audio output signals in response to preset option 6 and the knob 112 is untouched, the preset option 6 indication site 120(p) may provide a corresponding indication; such as providing a white color. While in this preset option 6 position with the knob 112 untouched, the other indication sites 120(k), 120(l), 120(m), 120(n) and 120(o) may provide a corresponding indication that they are neither designated nor providing the current audio function; such as relative darkness. If the knob touch indicator 122 is used, the indication site 124 may provide an indication that the knob is not being touched; such as relative darkness.

With continuing reference to FIGS. 4, 7 and 8, to achieve the second condition 210, the operator touches the knob 112. Because the knob 112 remains in the preset option 6 position (as determined by the position switch 302) while the knob 112 is being touched (as determined by the touch sensor touch sensor switch 304), preset option 6 continues to provide the audio output. If the audio function indicator 118 is used, the mark 114 will continue to point toward or designate the preset option 6 indication site 120(p). The preset option 6 indication site 120(p) may provide an indication corresponding to the fact that the preset option 6 position is designated while the knob 112 is touched; such as providing a blue color. While in this preset option 6 position with the knob 112 touched, the other indication sites 120(k), 120(l), 120(m), 120(n) and 120(o) may continue to provide a corresponding indication that they are neither designated nor providing the current audio function; such as relative darkness. If the knob touch indicator 122 is used, the indication site 124 may provide an indication that the knob is now being touched; such as providing a white color.

With continuing reference to FIGS. 4, 7 and 8, to achieve the next condition the operator begins sliding the knob 112 toward the preset option 1 position. As this motion begins, the knob 112 is slid to the preset option 5 position. This condition is considered an intermediate condition 220 in FIG. 7. Because the knob 112 is in the preset option 5 position (as determined by the position switch 302) and the knob 112 continues to be touched (as determined by the touch sensor touch sensor switch 304), preset option 6 continues to provide the audio output. If the audio function indicator 118 is used, the mark 114 will now point toward or designate the preset option 5 indication site 120(o). The preset option 5 indication site 120(o) may provide an indication corresponding to the fact that the preset option 5 position is designated while the knob 112 is touched; such as providing a blue color. Because preset option 6 continues to provide the audio output, the preset option 6 indication site 120(p) may provide a corresponding indication; such as providing a white color. While in this condition the other indication sites 120(k), 120(l), 120(m) and 120(n) may continue to provide a corresponding indication that they are neither designated nor providing the current audio function; such as relative darkness. If the knob touch indicator 122 is used, the indication site 124 may continue to provide an indication that the knob is being touched; such as providing a white color.

With continuing reference to FIGS. 4, 7 and 8, to achieve the next condition the operator continues sliding the knob 112 from the preset option 5 position toward the preset option 1 position. As this motion continues, the knob 112 is slid to the preset option 4 position. This condition is also considered an intermediate condition 220 in FIG. 7. Because the knob 112 is in the preset option 4 position (as determined by the position switch 302) and the knob 112 continues to be touched (as determined by the touch sensor touch sensor switch 304), preset option 6 continues to provide the audio output. If the audio function indicator 118 is used, the mark 114 will now point toward or designate the preset option 4 indication site 120(n). The preset option 4 indication site 120(n) may provide an indication corresponding to the fact that the preset option 4 position is designated while the knob 112 is touched; such as providing a blue color. Because preset option 6 continues to provide the audio output, the preset option 6 indication site 120(p) may provide a corresponding indication; such as providing a white color. While in this condition the other indication sites 120(k), 120(l), 120(m) and 120(o) may continue to provide a corresponding indication that they are neither designated nor providing the current audio function; such as relative darkness. If the knob touch indicator 122 is used, the indication site 124 may continue to provide an indication that the knob is being touched; such as providing a white color.

With continuing reference to FIGS. 4, 7 and 8, as the operator continues sliding the knob 112 toward the preset option 1 position, it should be understood that two additional intermediate conditions 220 in FIG. 7 will occur. Specifically, the knob 112 is slid to the preset option 3 position and then to the preset option 2 position. As the operation of the indication sites is similar to that explained above, no further details will be provided here. However, it should be noted that the knob 112 continues to be touched as it is moved through these intermediate conditions.

Still referring to FIGS. 4, 7 and 8, to achieve the third condition 230, the operator continues sliding the knob 112, into the preset option 1 position. Because the knob 112 is in the preset option 1 position (as determined by the position switch 302) and the knob 112 continues to be touched (as determined by the touch sensor touch sensor switch 304), preset option 6 continues to provide the audio output. If the audio function indicator 118 is used, the mark 114 will now point toward or designate the preset option 1 indication site 120(k). The preset option 1 indication site 120(k) may provide an indication corresponding to the fact that the preset option 1 position is designated while the knob 112 is touched; such as providing a blue color. Because preset option 6 continues to provide the audio output, the preset option 1 indication site 120(p) may provide a corresponding indication; such as providing a white color. While in this condition the other indication sites 120(l), 120(m), 120(n) and 120(o) may provide a corresponding indication that they are neither designated nor providing the current audio function; such as relative darkness. If the knob touch indicator 122 is used, the indication site 124 may continue to provide an indication that the knob is being touched; such as providing a white color.

Finally, with continuing reference to FIGS. 4, 7 and 8, to achieve the fourth and final condition 240, the destination audio function where preset option 1 provides the audio output, the operator releases the knob 112 in the preset option 1 position. Because the knob 112 is in the preset option 1 position (as determined by the position switch 302) and the knob 112 is no longer touched (as determined by the touch sensor touch sensor switch 304), preset option 1 now provides the audio output. Because the audio transmission device 100 is providing audio output signals in response to preset option 1 and the knob 112 is untouched, the preset option 1 indication site 120(k) may provide a corresponding indication; such as providing a white color. While in this preset option 1 position with the knob 112 untouched, the other indication sites 120(l), 120(m), 120(n), 120(o) and 120(p) may provide a corresponding indication that they are neither designated nor providing the current audio function; such as relative darkness. If the knob touch indicator 122 is used, the indication site 124 may provide an indication that the knob is not being touched; such as relative darkness. Note yet again that the audio transmission device 100 switches between audio input signals without the annoying “channel flipping” effect known in the prior art.

Numerous embodiments have been described, hereinabove. It will be apparent to those skilled in the art that the above methods and apparatuses may incorporate changes and modifications without departing from the general scope of this invention. It is intended to include all such modification and alterations in so far as they come within the scope of the appended claims or the equivalents thereof.

What is claimed is:

1. A method comprising the steps of:
(A) providing at least a first audio source;
(B) providing at least first, second, and third audio functions;
(C) providing an audio transmission device that is mountable to an associated vehicle, the audio transmission device comprising: (1) an audio input device that receives audio input signals from the audio source; (2) an audio output device that provides audio output signals in response to the audio input signals; (3) a knob that is movably adjustable with respect to the audio transmission device to adjust the audio transmission device to select between the audio functions; and, (4) a touch sensor that senses if the knob is being touched by an associated person and if the knob is not being touched by the associated person;
(D) providing the knob in a first position corresponding to the first audio function with the knob untouched to cause the audio transmission device to provide audio output signals in response to the first audio function;
(E) touching the knob while in the first position;
(F) moving the knob to a second position corresponding to the second audio function;
(G) moving the knob to a third position corresponding to the third audio function;
(H) releasing the knob in the third position to cause the audio transmission device to provide audio output signals in response to the third audio function;
wherein steps (D) though (H) are done in sequential order;
wherein during steps (E) though (G) the knob is continuously touched by the associated person; and,
wherein during steps (E) though (G) the audio transmission device continuously provides audio output signals in response to the first audio function.

2. The method of claim 1 wherein:
step (C) comprises the step of: providing the knob to be rotatably adjustable with respect to the audio transmission device;
step (F) comprises the step of: rotating the knob to the second position; and, step (G) comprises the step of: rotating the knob to the third position.

3. The method of claim 1 wherein:
step (C) comprises the step of: providing the knob to be slidably adjustable with respect to the audio transmission device;
step (F) comprises the step of: sliding the knob to the second position; and,
step (G) comprises the step of: sliding the knob to the third position.

4. The method of claim 1 wherein:
step (A) comprises the step of: providing at least first, second, and third audio sources; and,
step (B) comprises the step of: providing the at least first, second, and third audio functions to be the at least first, second, and third audio sources, respectively.

5. The method of claim 1 wherein:
step (A) comprises the step of: providing at least first and second audio sources each having at least first and second sub-audio choices; and,
step (B) comprises the steps of: (1) providing the first audio function to be a first preset comprising the first audio source combined with its first sub-audio choice; (2) providing the second audio function to be a second preset comprising the second audio source combined with its first sub-audio choice; and, (3) providing the third audio function to be a third preset comprising one of: (a) the first audio source combined with its second sub-audio choice; and (b) the second audio source combined with its second sub-audio choice.

6. The method of claim 1 wherein:
step (A) comprises the step of: providing the first audio source to be one of an AM radio tuner audio source; an FM radio tuner audio source; and, an XM radio receiver audio source; and,
step (B) comprises the step of: providing the at least first, second, and third audio functions to be first, second, and third radio tuner preset frequencies, respectively.

7. The method of claim 1 wherein:
step (C) comprises the step of: providing an audio function indicator having an indication site for each audio function; each indication site having at least first, second, and third indication options;
step (D) comprises the steps of causing: (1) the indication site for the first audio function to provide the first indication option; (2) the indication site for the second audio function to provide the third indication option; and, (3) the indication site for the third audio function to provide the third indication option;
step (E) comprises the steps of causing: (1) the indication site for the first audio function to provide the second indication option; (2) the indication site for the second audio function to provide the third indication option; and, (3) the indication site for the third audio function to provide the third indication option;
step (F) comprises the steps of causing: (1) the indication site for the first audio function to provide the first indication option; (2) the indication site for the second audio function to provide the second indication option; and, (3) the indication site for the third audio function to provide the third indication option;
step (G) comprises the steps of causing: (1) the indication site for the first audio function to provide the first indication option; (2) the indication site for the second audio function to provide the third indication option; and, (3) the indication site for the third audio function to provide the second indication option; and,
step (H) comprises the steps of causing: (1) the indication site for the first audio function to provide the third indication option; (2) the indication site for the second audio function to provide the third indication option; and, (3) the indication site for the third audio function to provide the first indication option.

8. The method of claim 7 wherein the first, second, and third indication options are one of audio options and visual options.

9. The method of claim 8 wherein:
the steps of causing the indication site to provide the first option each comprise the step of: causing the indication site to illuminate a first color;
the steps of causing the indication site to provide the second option each comprise the step of: causing the indication site to illuminate a second color that is color distinct from the first color; and,
the steps of causing the indication site to provide the third option each comprise the step of: causing the indication site to provide no illumination.

10. The method of claim 7 wherein:
step (C) comprises the step of: providing a knob touch indicator having an indication site having at least first and second options; and,
steps (D) through (H) each comprise the step of causing: (1) the indication site for the knob touch indicator to provide the second indication option when the knob is being touched; and, (2) the indication site for the knob touch indicator to provide the first indication option when the knob is released.

11. An audio system comprising:
at least a first audio source;
at least first and second audio functions;
an audio transmission device that is mountable to an associated vehicle, the audio transmission device comprising:
an audio input device that receives audio input signals from the audio source;
an audio output device that provides audio output signals in response to the audio input signals;
a knob that is movably adjustable with respect to the audio transmission device to adjust the audio transmission device to select between the audio functions;
an audio function indicator having an indication site for each audio function; each indication site having at least first, second, and third indication options;
a touch sensor that senses if the knob is being touched by an associated person and if the knob is not being touched by the associated person;
wherein the audio transmission device is adjustable: (1) from a first condition where: the touch sensor senses that the knob is not being touched; the knob is in a first position corresponding to the first audio function; the indication site for the first audio function has the first indication option; the indication site for the second audio function has the third indication option; and, the audio transmission device provides audio output signals in response to the first audio function; (2) to a second condition where: the touch sensor senses that the knob is being touched; the knob is in the first position corresponding to the first audio function; the indication site for the first audio function has the second indication option; and, the indication site for the second audio function has the third indication option; (3) then to a third condition where: the touch sensor senses that the knob is being touched; the knob is in the second position corresponding to the second audio function; the indication site for the first audio function has the first indication option; and, the indication site for the second audio function has the second indication option; and, (4) then to a fourth condition where: the touch sensor senses that the knob is not being touched; the knob is in the second position corresponding to the second audio function; the indication site for the first audio function has the third indication option; the indication site for the second audio function has the first indication option; and, the audio transmission device provides audio output signals in response to the second audio function; and,
wherein during and between the second and third conditions: (1) the touch sensor continuously senses that the knob is being touched; and, (2) the audio transmission device continuously provides audio output signals in response to the first audio function.

12. The audio system of claim 11 wherein the knob comprises:
a mark to indicate the knob position with respect to the audio source indicator.

13. The audio system of claim 11 wherein the first, second, and third indication options are audio options.

14. The audio system of claim 11 wherein the first, second, and third indication options are visual options.

15. The audio system of claim 14 wherein:
the first indication option for each audio function indicator is the illumination of a first color;
the second indication option for each audio function indicator is the illumination of a second color that is color distinct from the first color; and,
the third indication option for each audio function indicator is the removal of illumination.

16. The audio system of claim 11 wherein the knob is slidably adjustable with respect to the audio transmission device.

17. The audio system of claim 11 wherein:
the knob is rotatably adjustable with respect to the audio transmission device; and,
the audio transmission device comprises: an encoder that senses the angular position of the knob.

18. The audio system of claim 11 wherein:
the knob is rotatably adjustable with respect to the audio transmission device; and,
the audio transmission device comprises: a rotary switch that senses the angular position of the knob.

19. The audio system of claim 11 wherein:
the audio system comprises a second audio source; and,
the at least first and second audio functions are the at least first and second audio sources, respectively.

20. The audio system of claim 11:
further comprising a knob touch indicator having an indication site having at least first and second visual options;
wherein when the touch sensor senses that the knob is being touched by the associated person the indication site of the knob touch indicator provides the first visual option;
wherein when the touch sensor senses that the knob is not being touched by the associated person the indication site of the knob touch indicator provides the second visual option; and,
wherein all the audio function indication sites have at least first, second, and third visual indication options.
